(19) United States
(12) Patent Application Publication
(10) Pub. No.: US 2011/0005954 A1
(43) Pub. Date: Jan. 13, 2011

(54) CASE FOR HOLDING A HAND TOOL

(75) Inventor: Yu Jun ZHANG, Shanghai (CN)

Correspondence Address: SHUTTLEWORTH & INGERSOLL, P.L.C., 115 3RD STREET SE, SUITE 500, P.O. BOX 2107, CEDAR RAPIDS, IA, 52406, US

(73) Assignee: MERIDIAN INTERNATIONAL CO., LTD., Shanghai (CN)

(21) Appl. No.: 12/605,600

(22) Filed: Oct. 26, 2009

(30) Foreign Application Priority Data
Jul. 7, 2009 (CN) 200920077910.4

(51) Int. Cl. B65D 85/00; B65D 25/28; B65D 25/54; B25H 3/02

(52) U.S. Cl. 206/375; 220/756; 206/776

(57) ABSTRACT

In accordance with one aspect of the present invention, a case for holding a hand tool at a point of sale is provided. The hand tool has a working end and a handle. The handle projects from the case to form a handle for the case and the case engages the hand tool such that the hand tool is prevented from being removed from the case while simultaneously, the handle can be rotated with respect to the case to test a function of the hand tool. Before the case and the hand tool is purchased the hand tool is prevented from being removed from the case; however, the handle can be rotated with respect to the case when the case is in a closed position. After the hand tool is purchased the customer can break a seal and the case may be opened, thereby allowing the tool to be removed from the case when the case is in an open position.

### CROSS-REFERENCE TO RELATED APPLICATIONS

The present application claims the benefit of Chinese Application 2009200077910.4 filed Jul. 7, 2009, which is incorporated herein by reference.

### TECHNICAL FIELD

This invention relates to a case for displaying hand tools at a point of sale, and particularly a case that allows a customer to test the hand tool without removing the hand tool from the case.

### BACKGROUND INFORMATION

Tool sets are customarily sold in cases with multiple interchangeably driven bits. The cases are sealed at the point of sale to prevent the hand tool and/or the driven bits from being lost or stolen. Consequently, it is not possible for the customer to test the hand tool without opening the case and breaking the seal.

Previous disposable packages have been designed to allow the customer to test a tool while it remains in the package. Such packaging has been limited to scissor type hand tools wherein one handle is exposed and the other loop handle is enclosed in the packaging. The packaging has some room for the working end of the scissors to operate.

Heretofore, reusable cases have not been designed so a hand tool can be functionally tested while remaining in the case. Accordingly, there is a need for a case that provides for functional testing of the handle by the user, while securing the tool to the case.

### SUMMARY

In accordance with one aspect of the present invention, a case for holding a hand tool at a point of sale is provided. The hand tool has a working end and a handle. The handle projects from the case to form a handle for the case and the case engages the hand tool such that the hand tool is prevented from being removed from the case, while simultaneously the handle can be rotated with respect to the case to test a function of the hand tool. Before the case and the hand tool is purchased the hand tool is prevented from being removed from the case, but the handle can be rotated with respect to the case. After the hand tool is purchased the customer can break a seal and the case may be opened, thereby allowing the tool to be removed from the case.

### BRIEF DESCRIPTION OF THE DRAWINGS

These and other features and advantages of the present invention will be better understood by reading the following detailed description, taken together with the drawings wherein:

FIG. 1 is a perspective view of the front side of the tool case in the open position and the tool removed from the tool case;

FIG. 2 is a perspective view of the retaining member of the tool case;

FIG. 3 is a perspective view of the front side of the tool case in the open position with the tool combined with the tool case; and

FIG. 4 is a perspective view of the front side of the tool case with the tool combined with the case of a second embodiment.

### DETAILED DESCRIPTION OF THE PREFERRED EMBODIMENTS

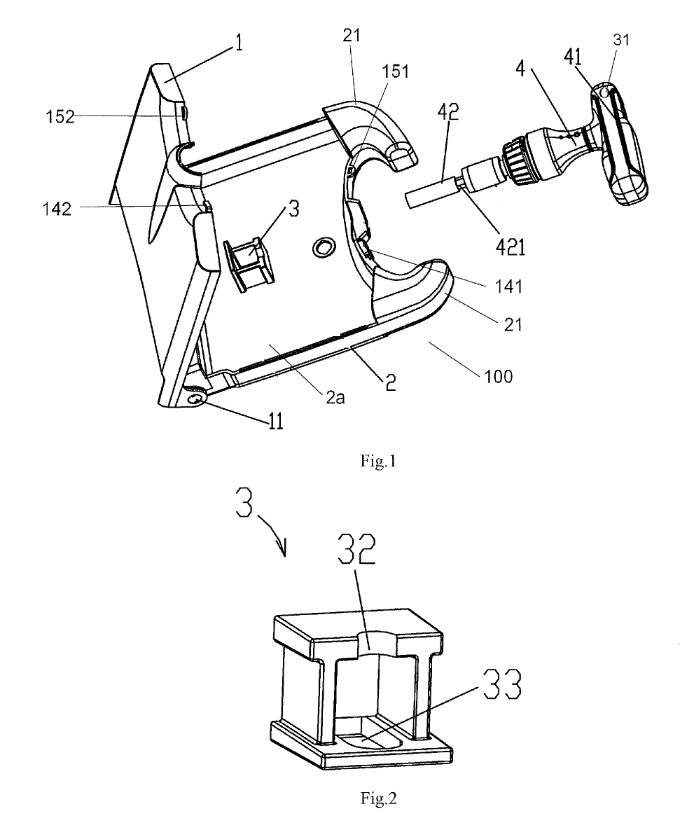

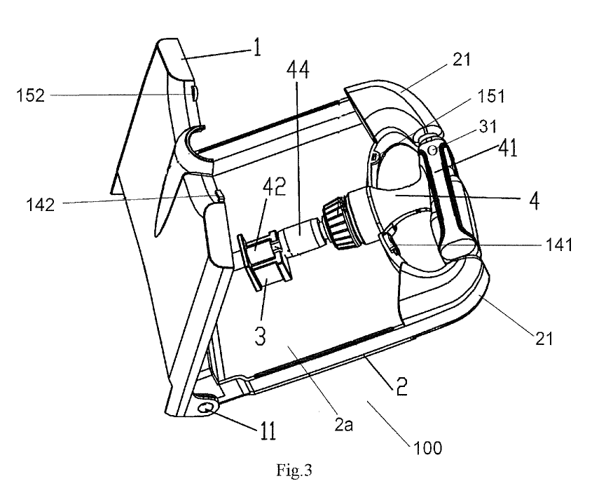

With reference to FIGS. 1-4, the hand tool 4, in accordance with an embodiment, is a ratcheting type driver 4; however, one skilled in the art would understand that the present disclosure is not so limited. The driver 4 has a working end 42 and a handle 41. The handle 41 projects from the case 100 to form a handle 41 for the case 100 and the working end 42 is attached inside the case 100 by a retaining member 3, to prevent the hand tool 4 from being removed.

The case 100 in accordance with an embodiment includes a first side 1 and a second side 2 pivotable about a pivot point 11. The case 100 is suitable for carrying a hand tool 4 and may be adapted to carry hand tool accessories (not shown). In an alternate embodiment, the case 100 does not open and the hand tool accessories are adapted to fit into receptacles on the front of the case. In yet another embodiment, the case is a disposable package for holding and displaying the hand tool 4 at a point of sale. In a further embodiment, the case 100 has a transparent first side 1, made of any suitable material, such as plastic, to allow customers to see the contents of the case.

In an embodiment, the first side 1 and second side 2 of the case 100 are selectively lockable. A sliding latch 141 on the second side 2 engages a protrusion 142 on the first side 1 to selectively hold the case 1 in a closed position. Also, the case 100 may be fixed in the closed position at the point of sale. The first side 1 and second side 2 of the case 100 have corresponding eyes 151 and 152, respectively. The eyes 151 and 152 are adapted to receive a zip-tie to hold the case 4 in the closed position.

At the point of sale, it is preferable to have one or more ways of displaying the case 100. In an embodiment, the handle 41 of the hand tool 4 has an aperture 31 having an axis perpendicular to a first side 1 of the case 100 when the opposed handle portions 21 are aligned with the handle 4. The aperture 31 allows the case 1 to be displayed on, for example a hanger on a display rack.

The retaining member 3 combines with the inside wall 2a of the case 100 and is adapted to receive the hand tool 4 and hold the working end 42 of the hand tool 4 in position when the case 100 is closed. In the illustrated embodiment, the retaining member 3 has a semi-circular cut-out 32 and hole 33 adapted to receive the working end 42 of the hand tool 4. The top edge 421 of the working end 42 fits underneath the bottom of edge of the semi-circular cut-out 32. When the case 100 is in the closed position, the hand tool 4 cannot be removed from the retaining member 3. When the case 100 is opened, the hand tool 4 is readily removable from the retaining member 3.

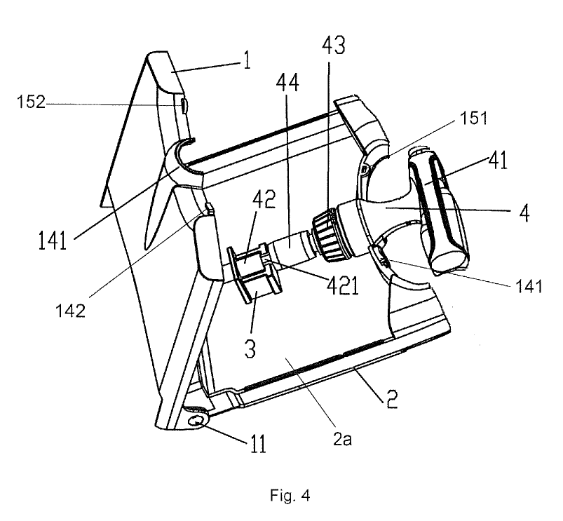

In an embodiment, the case 100 has two opposed projecting handle portions 21. The projecting handle portions 21 form part of the handle for the case 100. When the hand tool 4 is combined with the case 100, the opposed handle portions 21 and the handle 41 of the hand tool 4 form a generally continuous handle for the case 100. In an alternative embodiment, shown in FIG. 4, the projecting handle portions 21 have been removed and the handle 41 of the hand tool 4 is the sole handle for the case. In both embodiments, the handle 41 of the hand tool 4 projects from the case and is rotatable with respect to the case 100. The aforementioned designs advantageously allow the customer to test the function of the hand tool 4 by rotating its handle 41 with respect to the case 100.

In an embodiment, the handle 41 of the hand tool 4 is generally T-shaped and has an ergonomic feel to comfortably form to a customer's hand. However, any shape or variation of the handle 41 may be provided, so long as it provides a comfortable grip for the customer.

While the principles of the invention have been described herein, it is to be understood by those skilled in the art that this description is made only by way of example and not as a limitation as to the scope of the invention. Other embodiments are contemplated within the scope of the present invention in addition to the exemplary embodiments shown and described herein. Modifications and substitutions by one of ordinary skill in the art are considered to be within the scope of the present invention, which is not to be limited except by the following claims.

We claim:

1. An apparatus comprising:
a case; and
a hand tool having a working end and a handle, wherein the handle projects from the case to form a handle for the case, and the case engages the hand tool such that the hand tool is prevented from being removed from the case while simultaneously, the handle can be rotated with respect to the case to test a function of the hand tool.

2. The apparatus of claim 1, wherein the hand tool is prevented from being removed from the case and the handle can be rotated with respect to the case when the case is in a closed position

3. The apparatus of claim 1, wherein the hand tool is allowed to be removed from the case when the case is in an open position

4. The apparatus of claim 1, wherein the case comprises two opposed projecting handle portions wherein, the opposed handle portions and the handle of the hand tool are positioned relative to one another to form a generally continuous handle of the case.

5. The apparatus of claim 4, wherein the tool handle has an aperture, the aperture having an axis perpendicular to a display side of the case when the opposed handle portions and the handle are in alignment.

6. The apparatus of claim 1, wherein the case is a case.

7. The apparatus of claim 1, wherein the hand tool is a ratcheting driver.

8. The apparatus of claim 7, wherein the case is adapted to carry interchangeable driven bits.

9. The apparatus of claim 1, and further comprising: a retaining member combinable with an interior wall of the case and adaptable to retain the working end of the hand tool.

10. The apparatus of claim 1, wherein the handle is ergonomically shaped.

11. The apparatus of claim 1, wherein the handle is generally T-shaped.

12. The apparatus of claim 1, wherein the case has a transparent side.

13. A case for holding and displaying a hand tool at a point of sale, the case comprising:
two opposed handle portions wherein the two opposed handle portions are positioned on opposite sides of the case such that when a hand tool is positioned within the case, a projecting portion of a handle of the hand tool fit together to form a generally continuous handle of the case; and wherein the case is engageable with the hand tool such that the handle can be rotated to test the function of the hand tool while simultaneously, the hand tool is prevented from being removed from the case.

14. The case of claim 13, wherein the tool handle has an aperture having an axis perpendicular to a display side of the case when the two opposed handle portions and the handle are in alignment.

15. The case of claim 13, wherein the hand tool is prevented from being removed from the case and the handle can be rotated with respect to the case when the case is in a closed position

16. The case of claim 13, wherein the hand tool is allowed to be removed from the case when the case is in an open position

17. A case comprising: a hand tool having a working end and a handle, wherein the handle forms a handle for the case and the case engages the hand tool such that the handle is prevented from being removed from the case while simultaneously, the handle can be rotated with respect to the case to test a function of the hand tool.

18. The case of claim 17, wherein the handle projects from the case and case comprises two opposed projecting handle portions wherein, the opposed handle portions and the handle of the hand tool are positioned relative to one another to form a generally continuous handle of the case.

19. The case of claim 18, wherein the tool handle has an aperture, the aperture having an axis perpendicular to a display side of the case when the opposed handle portions and the handle are in alignment.

20. The case of claim 13 having a retaining member combinable with an interior wall of the case and adaptable to retain the working end of the hand tool.
